(19) United States
(12) Patent Application Publication
(10) Pub. No.: US 2026/0166547 A1
(43) Pub. Date: Jun. 18, 2026

(54) MICROSTRUCTURED SUBSTRATE INCLUDING CONNECTED WELLS

(71) Applicant: Solventum Intellectual Properties Company, Maplewood, MN (US)

(72) Inventors: Brian J. GATES, Maplewood, MN (US); Steven P. SWANSON, Maplewood, MN (US); Kurt J. HALVERSON, Maplewood, MN (US); Alexi J. YOUNG, Maplewood, MN (US); Alexandra L. CRAMPTON, Maplewood, MN (US); Emily S. SAVELA, Maplewood, MN (US)

(73) Assignee: Solventum Intellectual Properties Company, Maplewood, MN (US)

(21) Appl. No.: 19/129,363

(22) PCT Filed: Oct. 3, 2023
(86) PCT No.: PCT/IB2023/059930

§ 371 Date: May 13, 2025

Related U.S. Application Data
(60) Provisional application No. 63/425,473, filed on Nov. 15, 2022.

(51) Int. Cl. B01L 3/00

(52) U.S. Cl. CPC B01L 3/50273; B01L 2200/0684; B01L 2300/0829; B01L 2400/0406

(57) ABSTRACT

The present disclosure provides microstructured substrates. A microstructured substrate includes microstructures extending across a surface of the microstructured substrate. The microstructures include an array of interconnected wells and at least some of the wells are fluidically connected to at least two adjacent wells, each connection via a vent. Each well has an open volume ranging from 100 femtoliters to 1 microliter. At least a portion of an exterior surface of the microstructures are configured to allow capillary action.

### BACKGROUND

Numerous devices (e.g., diagnostic devices), fluid transport films, etc., employ capillary action to move an aqueous fluid. Further developments in substrates that use capillary motion would be desirable.

### SUMMARY

In a first aspect, a microstructured substrate is provided. The microstructured substrate comprises a plurality of microstructures extending across a first surface of the microstructured substrate. The microstructures comprise an array of interconnected wells and at least some of the wells are fluidically connected to at least two adjacent wells, each connection via a vent. Each well has an open volume ranging from 100 femtoliters to 1 microliter. At least a portion of an exterior surface of the plurality of microstructures are configured to allow capillary action.

It has been discovered that devices and methods according to at least certain embodiments of this disclosure can provide removal of solid particles (e.g., red blood cells) from very small (e.g., microliter) volumes of fluids (e.g., blood).

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1A is a schematic perspective view of a portion of an exemplary microstructured substrate having an array of fluidically connected wells.

FIG. 1B is a schematic top view of a portion of a microstructured substrate having an array of fluidically connected wells having a circular shape.

FIG. 2 is a schematic cross-sectional view of a portion of an exemplary microstructured substrate having an array of fluidically connected wells.

FIG. 3A is a schematic top view of a portion of a microstructured substrate having an array of fluidically connected wells having a circular shape and triangular vents.

FIG. 3B is a schematic perspective view of a portion of the microstructured substrate of FIG. 3A.

FIG. 4A is a schematic top view of a portion of a microstructured substrate having an array of fluidically connected wells having a circular shape and rounded bottom surfaces.

FIG. 4B is a schematic perspective view of a portion of the microstructured substrate of FIG. 4A.

FIG. 5A is a schematic top view of a portion of a microstructured substrate having an array of fluidically connected wells having a triangular shape.

FIG. 5B is a close-up view of a portion of FIG. 5A.

FIG. 5C is a schematic perspective view of a portion of the microstructured substrate of FIG. 5A.

FIG. 6A is a schematic top view of a portion of a microstructured substrate having an array of fluidically connected wells having a square shape.

FIG. 6B is a schematic perspective view of a portion of the microstructured substrate of FIG. 6A.

FIG. 7A is a schematic top view of a portion of a microstructured substrate having an array of fluidically connected wells having a hexagonal shape.

FIG. 7B is a schematic perspective view of a portion of the microstructured substrate of FIG. 7A.

FIG. 8A is an exploded generalized schematic diagram of a device in which an exemplary microstructured substrate could be employed.

FIG. 8B is a generalized schematic top view of the device of FIG. 8A.

FIG. 8C are generalized schematic top views of two components used to attach a pump affixed to the device of FIGS. 8A-8B.

FIG. 8D is a generalized schematic perspective view of the device of FIGS. 8A-8B adapted to be attached to a pump.

FIG. 9 is a perspective view of a generalized schematic diagram of a microstructured substrate for use in a device.

While the above-identified figures set forth several embodiments of the disclosure other embodiments are also contemplated, as noted in the description. The figures are not necessarily drawn to scale. In all cases, this disclosure presents the invention by way of representation and not limitation.

### DETAILED DESCRIPTION OF ILLUSTRATIVE EMBODIMENTS

As used herein, the term “microreplication” means the production of a microstructured surface through a process where the structured surface features retain an individual feature fidelity during manufacture.

As used herein, the term “microstructure” encompasses both structures (i.e., features) that protrude above a major surface of a substrate, and structures that are recessed below a major surface of a substrate. Combinations of protruding and recessed features are contemplated. By a microstructure is further meant that the structure is a predetermined, molded structure (e.g., as obtained by molding a polymeric thermoplastic resin against a tooling surface that comprises the negative of the microstructure desired to be provided on a first major side of a substrate) with dimensions ranging from about 5 to about 3000 micrometers in at least two orthogonal directions. One of these orthogonal directions may often be normal to the plane of the substrate (e.g., along the z-axis,) thus this dimension can comprise, e.g., a protrusion height or a recess depth.

As used herein, the term “capillary action” refers to fluid flow absent the assistance of external forces (e.g., pressure, gravity, vacuum, etc.). Often capillary action occurs for an aqueous fluid in contact with a hydrophilic surface. An aqueous fluid comprises 50% or more by volume water.

As used herein, the term “hydrophilic” refers to a surface that is wet by aqueous solutions and does not express whether or not the material absorbs aqueous solutions. By “wet” it is meant that the surface exhibits spontaneous wicking when contacted with an aqueous fluid. By “spontaneous” it is meant occurring without external forces. In some embodiments, a hydrophilic surface exhibits an advancing (maximum) water contact angle of less than 90°, preferably 45° or less.

As used herein, the term “hydrophobic” refers to a surface that lacks spontaneous wicking when contacted with an aqueous fluid. In some embodiments, a hydrophobic surface exhibits an advancing water contact angle of 70° or greater, preferably 90° or greater.

As used herein, “curing” means the hardening or partial hardening of a composition by any mechanism, e.g., by heat, light, radiation, e-beam, microwave, chemical reaction, or combinations thereof. As used herein, the term “hardenable” refers to a material that can be cured or solidified, e.g., by heating to remove solvent, heating to cause polymerization, chemical crosslinking, radiation-induced polymerization or crosslinking, or the like. As used herein, “cured” refers to a material or composition that has been hardened or partially hardened (e.g., polymerized or crosslinked) by curing.

As used herein, a polymeric “film” is a polymer material in the form of a generally flat sheet that is sufficiently flexible and strong to be processed in a roll-to-roll fashion. By roll-to-roll, what is meant is a process where material is wound onto or unwound from a support, as well as further processed in some way. Examples of further processes include coating, slitting, blanking, and exposing to radiation, or the like. Polymeric films can be manufactured in a variety of thicknesses, ranging in general from about 5 micrometers to 1000 micrometers.

As used herein, “solid” refers to the state of matter that is not liquid or gas, and a solid has a stable three-dimensional shape.

As used herein, “fluid” refers to a composition that includes a liquid (i.e., the state of matter that is not solid or gas) and encompasses solutions, suspensions, and emulsions.

As used herein, “exterior surface” with respect to a microstructure refers to an outermost surface of the microstructure.

As used herein, “thermoplastic” refers to a polymer that flows when heated sufficiently above its glass transition point and become solid when cooled. In contrast, “thermoset” refers to a polymer that permanently sets upon curing and does not flow upon subsequent heating. Thermoset polymers are typically crosslinked polymers.

As used herein, the term “glass transition temperature” (Tg), of a polymer refers to the transition of a polymer from a glassy state to a rubbery state and can be measured using Differential Scanning calorimetry (DSC), such as at a heating rate of 10° C. per minute in a nitrogen stream. When the Tg of a monomer is mentioned, it is the Tg of a homopolymer of that monomer. The homopolymer must be sufficiently high molecular weight such that the Tg reaches a limiting value, as it is generally appreciated that a Tg of a homopolymer will increase with increasing molecular weight to a limiting value. The homopolymer is also understood to be substantially free of moisture, residual monomer, solvents, and other contaminants that may affect the Tg. A suitable DSC method and mode of analysis is as described in Matsumoto, A. et. al., J. Polym. Sci. A., Polym. Chem. 1993, 31, 2531-2539.

As used herein, “transparent” refers to a material (e.g., a layer) that has at least 50% transmittance, 70% transmittance, or optionally greater than 90% transmittance over at least the 400 nanometer (nm) to 700 nm portion of the visible light spectrum.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

As noted above, at least a portion of an exterior surface of the plurality of microstructures are configured to allow capillary action. Capillary action is well known in the art to refer to fluid flow absent the assistance of external forces, typically for an aqueous fluid (having 50% or more by volume water) in contact with a hydrophilic surface. Accordingly, once a fluid is introduced to microstructured substrate, the fluid is spontaneously transported along the exterior surfaces of the microstructures, thereby spreading out within the area of the microstructures. Two general factors that influence the ability of microstructures to spontaneously transport fluids are (i) the structure or topography of the surface (e.g., capillarity, shape of the cavity) and (ii) the nature of the surface (e.g., surface energy). To achieve the desired amount of fluid transport capability a designer may adjust the structure or topography of the substrate layer and/or adjust the surface energy of the capillary microstructured surfaces. In order to achieve wicking, a surface of the capillary microstructures must be capable of being “wet” by the liquid (e.g., liquid state of matter) to be transported. Optionally, the susceptibility of a solid surface to be wet by a liquid is characterized by the contact angle that the liquid makes with the solid surface after being deposited on a horizontally disposed surface and allowed to stabilize thereon. This angle is sometimes referred to as the “static equilibrium contact angle,” and sometimes referred to herein merely as “advancing contact angle.” In some cases, a material is considered hydrophilic if it has an advancing contact angle of less than 90 degrees, whereas a hydrophilic surface exhibits an advancing (maximum) water contact angle of less than 90°, preferably 45° or less.

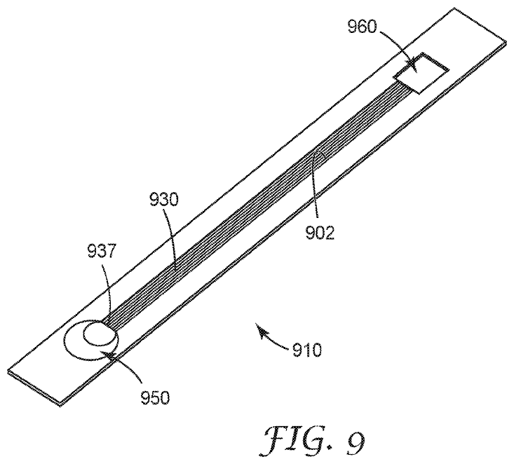

Enough of the exterior surfaces of the microstructures need to be hydrophilic to make the microstructured substrate capable of capillary action to transport the fluid (e.g., blood) throughout the device once the fluid has been introduced via the first aperture such that the solid particles can have access to the open volume between microstructures to be able to settle out of the bulk of the fluid. For example, referring to FIG. 9, the first aperture 950 may be provided as a reservoir configured to hold at least a certain minimum volume of fluid. The reservoir may be defined by a portion of the microstructured substrate 910 that is adjacent to one end 937 of the microstructures 930. Likewise, the second aperture 960 may be a reservoir configured to hold fluid as it exits the microstructured surface 902 of the microstructured substrate 910. It is noted that the microstructured surface 902 does not show interconnected wells but rather a general representation of a linear microstructures.

In some cases, 50% or more of the area of the exterior surface of the microstructures is capable of capillary action, 60%, 70%, 80%, 90%, or 95% or more of the exterior surface of the microstructures is capable of capillary action. Hydrophilicity of the exterior surface of the microstructures, according to any device described herein, can be achieved through one or more of material selection, additives included in the material, or surface treatment. In some embodiments, the microstructures have an exterior surface including a surfactant, a surface treatment, a hydrophilic polymer, or any combination thereof. Suitable surfactants include for instance and without limitation, C8-C18 alkane sulfonates; C8-C18 secondary alkane sulfonates; alkylbenzene sulfonates; C8-C18 alkyl sulfates; alkylether sulfates; sodium laureth 4 sulfate; sodium laureth 8 sulfate; dioctylsulfosuccinate, sodium salt; lauroyl lacylate; stearoyl lactylate; or any combination thereof. One or more surfactants can be applied by conventional methods, such as by wiping a coating of the surfactant on the surface of the microstructures and allowing the coating to dry. A suitable surface treatment includes a hydrophilic coating comprising plasma deposited silicon/oxygen materials and/or diamond-like glass (DLG) materials. Plasma deposition of each of silicon/oxygen materials and DLG material is described, for instance, in PCT Publication No. WO 2007/075665 (Somasiri et al.). Further, examples of suitable DLG materials are disclosed in U.S. Pat. No. 6,696,157 (David et al.), U.S. Pat. No. 6,881,538 (Haddad et al.), and U.S. Pat. No. 8,664,323 (Iyer et al.). Suitable hydrophilic polymers include for instance and without limitation, a polyester, a polyamide, a polyurethane, a poly(vinyl alcohol), a poly(alkylene glycol), a poly(alkylene oxide), a poly(vinyl pyrrolidone), a rubber elastomer, or any combination thereof.

In a first aspect, the present disclosure provides a microstructured substrate. The microstructured substrate comprising a plurality of microstructures extending across a first surface of the microstructured substrate, wherein the microstructures comprise an array of interconnected wells; wherein at least some of the wells are fluidically connected to at least two adjacent wells, each connection via a vent; wherein each well has an open volume ranging from 100 femtoliters to 1 microliter; and wherein at least a portion of an exterior surface of the plurality of microstructures are configured to allow capillary action.

Various devices, fluid transport films, etc., employ capillary action to move an aqueous fluid. For instance, as described in PCT Publications WO 2000/042958 (Johnston et al.), WO 2012/1589990 (Ludowise et al.), WO 2015/164632 (Halverson et al.), WO 2015/164468 (Meuler et al.), WO 2021/124165 (Swanson et al.), incorporated herein by reference.

Microstructured substrates according to at least certain embodiments of the present disclosure may be used for aqueous fluid transport via capillary action. Another exemplary use for articles that provide capillary flow is for the separation of particles from fluids, such as described in co-owned Application Ser. Nos. 63/425,468 (Docket No. PA100124US02) and 63/425,483 (Docket No. PA100776US01).

In addition to particles in general, red blood cells may be removed from blood. In centralized hospital or clinical laboratories, the separation of red blood cells is achieved via centrifugation. The separation process requires large (e.g., milliliter) volumes of blood collected intravenously in test tubes. During centrifugation red blood cells are packed at the bottom of the tube, leaving the remainder of the blood (e.g., cell-free plasma) accessible in the top layer for further analysis. In these centralized settings, biomarker detection is then typically performed on large, complex analyzers capable of automated liquid handling and access to frequent validation of assay performance via calibration. Point of care blood analyzers used outside a central lab also require removal of red blood cells prior to analysis. Access to intravenous quantities of blood and benchtop centrifugation is frequently not available or too time consuming in situations where a rapid result is required. Finger pricks provide blood volumes of around 5 microliters. Glucose test strips typically receive blood volumes less than 1 microliter and are subject to the interferences cited above. Removal of red blood cells from these small volumes remains a challenge.

There is a need in point of care biomarker analysis for simple, efficient separation of red blood cells from microliter quantities of blood without hemolysis, dilution, or significant loss of blood to dead space. One suitable use for microstructured substrates according to the present disclosure is to spread out a small volume blood sample and provide wells into which red blood cells can settle to separate from the blood.

Without wishing to be bound by theory, it is believed that the microstructured substrates according to at least certain embodiments of the present disclosure minimize the occurrence of trapped air bubbles as small volumes of a fluid move through the microstructures of the substrate via capillary action.

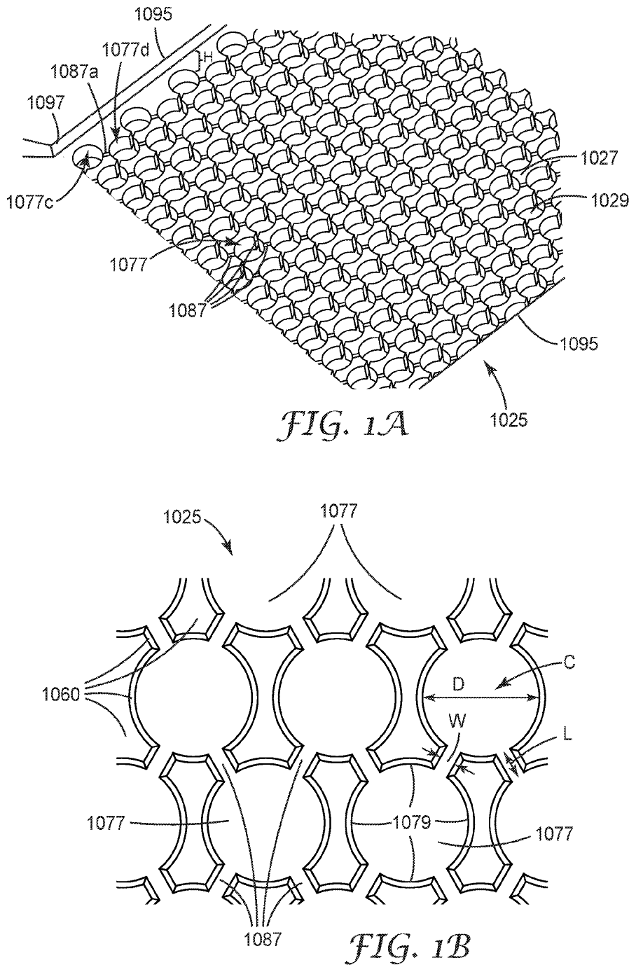

Referring to FIG. 1A, a schematic perspective view is provided of a portion of an exemplary microstructured substrate 1025, wherein the plurality of microstructures 1060 comprise an array of fluidically connected wells 1077, wherein at least some of the wells 1077 are fluidically connected to at least two adjacent wells 1077, each connected via a vent 1087. FIG. 1B is a schematic top view of a portion of the microstructured substrate 1025 of FIG. 1A, having an array of fluidically connected wells 1077 having circular shapes connected to adjacent wells 1077 by vents 1087. The side walls 1079 of a well 1077 are also indicated in FIG. 1B. The plurality of microstructures 1060 include walls, top surfaces, bottom surfaces, etc., of the microstructured substrate 1025, and define the voids of the wells 1077 and vents 1087.

By “adjacent”, with respect to two wells, means a (e.g., first) well that is next to another (e.g., second) well without any other (e.g., third) wells located in between the two (e.g., first and second) wells. As indicated in FIG. 1B, two adjacent wells are fluidically connected to each other by a vent 1087, which has a smaller width (“W”) than a diameter (“D”) of the well 1077. The diameter D is the longest line that crosses through a center point (“C”) of a well 1077. Typically, the vent 1087 also has a smaller length (“L”) than a diameter D of the well 1077.

In some embodiments, at least some of the vents have a width of 1 micrometer or greater, 2 micrometers, 3 micrometers, 4 micrometers, 5 micrometers, 6 micrometers, 7 micrometers, 8 micrometers, 9 micrometers, 10 micrometers, 11 micrometers, 12 micrometers, 13 micrometers, 14 micrometers, or 15 micrometers or greater; and 40 micrometers or less, 38 micrometers, 36 micrometers, 34 micrometers, 32 micrometers, 30 micrometers, 28 micrometers, 26 micrometers, 24 micrometers, 20 micrometers, 18 micrometers, 16 micrometers, 14 micrometers, 12 micrometers, or 10 micrometers or less, such as ranging from 1 micrometer to 40 micrometers. In the particular structure shown in FIGS. 1A-B, the wells 1077 in the center of the microstructured substrate 1025 are each connected to 4 other wells 1077, with each connection being via a vent 1087 (e.g., a center well has at least one other well located between it and a perimeter of the microstructured substrate). There are also wells 1077 located adjacent a perimeter 1095 that are connected to just one or two adjacent wells 1077 via vents 1087. For example, referring to FIG. 1A, well 1077c is in a corner of the array and is attached to just one other well 1077d via a vent 1087a. Similarly, wells can be attached to three other adjacent wells via vents, four, five, six, seven, eight, nine, ten, eleven, or twelve other adjacent wells via vents.

Referring to FIG. 2, a schematic cross-sectional view of a portion of an exemplary microstructured substrate 1025 is provided. The microstructured substrate 1025 has an array of fluidically connected wells 1077, although the fluid connections are not shown in this view. In some cases, a land thickness (“L”) of substrate material is present between a bottom surface 1029 of the wells 1077 and a bottom surface 1023 of the microstructured substrate 1025. The land thickness L may provide dimensional stability to the microstructured substrate 1025 useful for robust handling of the microstructured substrate 1025, and is typically between 2 millimeters (mm) and 250 mm, such as between 10 mm and 50 mm.

In this particular embodiment, one or more wells 1077 have at least one side wall 1079 that has an angled slope with respect to at least one of a top surface 1027 of the well 1077 or a bottom surface 1023 of the microstructured substrate 1025. By an angled slope is meant that a side wall 1079 is not perpendicular to at least one of the top surface 1027 of the well 1077 or the bottom surface 1023 of the microstructured substrate 1025, (e.g., within plus or minus 10 degrees of perpendicular). When the microstructured substrate 1025 is made by certain methods (e.g., as obtained by molding a polymeric thermoplastic resin against a tooling surface that comprises the negative of the microstructure desired to be provided on a first major side of a substrate), having a well 1077 with a side wall 1079 angled such that the diameter of the well is greater at the top surface 1027 than at the bottom 1029 of the well, it can be easier to remove the tooling surface from a formed well.

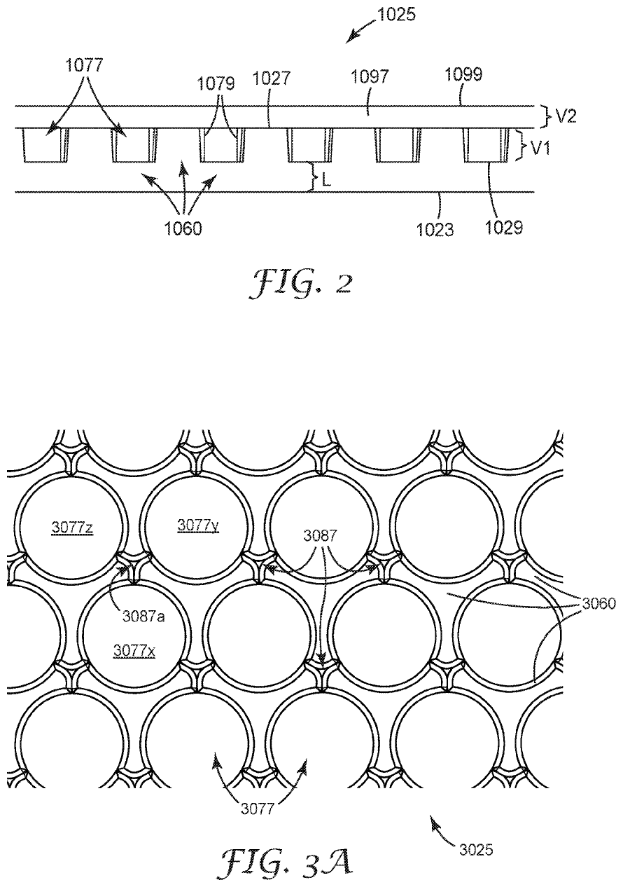

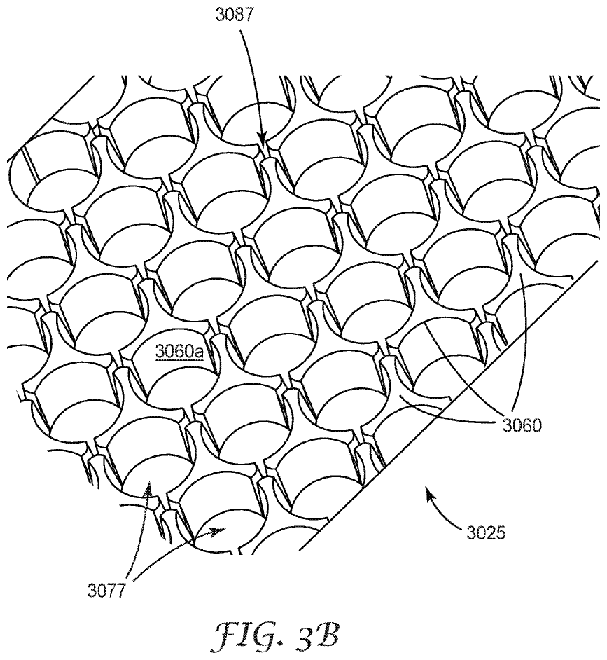

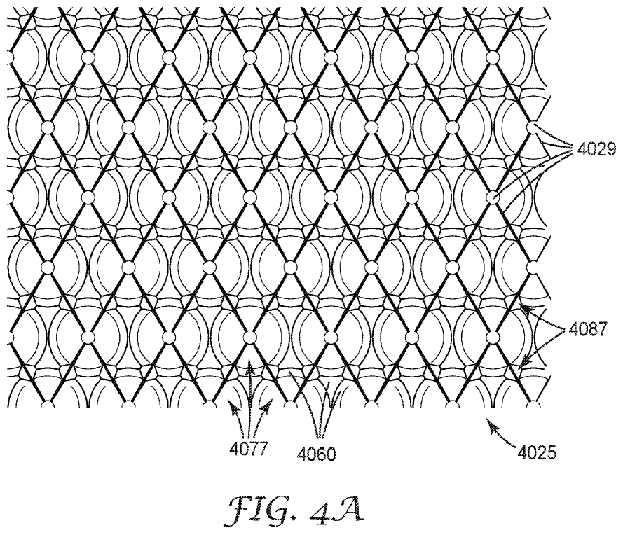

The shape of the wells is not particularly limited and can include a curvilinear shape, a polygonal shape, an irregular shape, or combinations thereof. In some embodiments, the wells comprise a circular shape, a triangular shape, a quadrilateral shape, an elliptical shape, or combinations thereof. In cases where a well comprises a shape having a corner, a vent is optionally located at the corner (e.g., to decrease the likelihood of trapping an air bubble in the corner). The vent shapes can also vary. Several exemplary suitable shapes for microstructured substrates are described in detail below with respect to FIGS. 3A-7B.

Typically, each well has an open volume large enough to hold at least one settled particle (e.g., red blood cell), such as 100 femtoliters or greater, 250 femtoliters, 500 femtoliters, 750 femtoliters, 1 picoliter, 100 picoliters, 250 picoliters, 500 picoliters, 750 picoliters, 1 nanoliter, 100 nanoliters, 200 nanoliters, 300 nanoliters, 400 nanoliters, 500 nanoliters, 600 nanoliters, 700 nanoliters, 800 nanoliters, or 900 nanoliters or greater; and 1 microliter or less, 900 nanoliters, 800 nanoliters, 700 nanoliters, 600 nanoliters, 500 nanoliters, 400 nanoliters, 300 nanoliters, 200 nanoliters, 100 nanoliters, 1 nanoliter, 750 picoliters, 500 picoliters, 250 picoliters, 1 picoliter, 750 femtoliters, or 500 femtoliters or less. Stated another way, in some cases each well has an open volume ranging from 100 femtoliters to 1 microliter or 500 femtoliters to 0.1 microliters.

Some typical dimensions for each well include a depth (i.e., a distance between a top surface 1027 of the microstructured substrate 2025 and a bottom surface of a well 1029, as shown in FIG. 1A and FIG. 2) of 50 microliters or greater, 75 microliters, 100 microliters, 125 microliters, 150 microliters, 175 microliters, 200 microliters, 225 microliters, 250 microliters, 275 microliters, 300 microliters, 325 microliters, or 350 microliters or greater; and 500 microliters or less, 475 microliters, 450 microliters, 425 microliters, 400 microliters, 375 microliters, 350 microliters, 325 microliters, 300 microliters, 275 microliters, 250 microliters, 225 microliters, 200 microliters, 175 microliters, or 150 microliters or less. This same range of distance is also applicable to a diameter of a well. As noted above, the diameter is the longest line that passes through a center point of the shape.

Preferably, at least some of the vents between wells are located at a same depth as a bottom surface of the adjacent wells. This assists in urging air bubbles to exit a well instead of getting trapped near the bottom of the well. In some embodiments, a vent has a total depth equal to a total depth of an adjacent well, although this is not a requirement. When a microstructured substrate is formed using a tool, making the vent have the same depth as an adjacent well tends to be more practical than making vents that connect just the lower portions of two wells. In contrast, when a microstructured substrate is made by laminating two more layers together, it may be practical to include the vents just in a single layer, such as the layer that includes the bottom surfaces of the wells.

Referring again to FIG. 1A and FIG. 2, in some embodiments, the microstructured substrate 1025 further includes at least one sidewall 1097 disposed along a perimeter 1095 of the first surface 1027 of the microstructured substrate 1025. The one or more sidewalls 1097 has a height (“H”) that extends beyond a top surface 1027 of the plurality of microstructures 1060 by 50 to 250 micrometers. In select embodiments, the first surface 1027 of the microstructured substrate 1025 together with the at least one sidewall 1097 defines a first open volume (“V1”) that is a total of open space located within the wells 1077 and the vents 1087, wherein a top surface 1099 of the at least one sidewall 1095 together with the top surface 1027 of the plurality of microstructures 1060 defines a second open volume (“V2”) adjacent to the first open volume V1, wherein the first open volume V1 is larger than the second open volume V2.

Referring to FIG. 3A, a schematic top view is provided of a portion of a microstructured substrate 3025 having an array of fluidically connected wells 3077 having a circular shape and triangular vents 3087 that connect three wells 3077 together. For instance, as shown in the figure, vent 3087a allows flow of fluid between each of wells 3077x, 3077y, and 3077z by connecting the three wells together. FIG. 3B provides a perspective view of a portion of the microstructured substrate 3025 of FIG. 3A to give an alternate view of the microstructures 3060. One way of providing such microstructures 3060 as are located in a center (e.g., not adjacent to a perimeter) of the microstructured substrate 3025, such as 3060a, is to form a series of spaced apart (e.g., symmetric) curved trilobal segments.

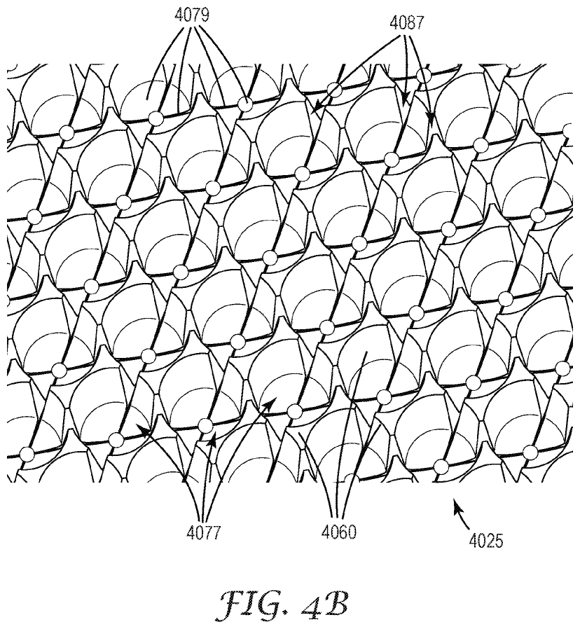

Referring to FIG. 4A, a schematic top view is provided of a portion of a microstructured substrate 4025 having an array of fluidically connected wells 4077 having a circular shape and rounded bottom surfaces 4029, connected by vents 4087. FIG. 4B provides a schematic perspective view of a portion of the microstructured substrate 4025 of FIG. 4A to give an alternate view of the microstructures 4060.

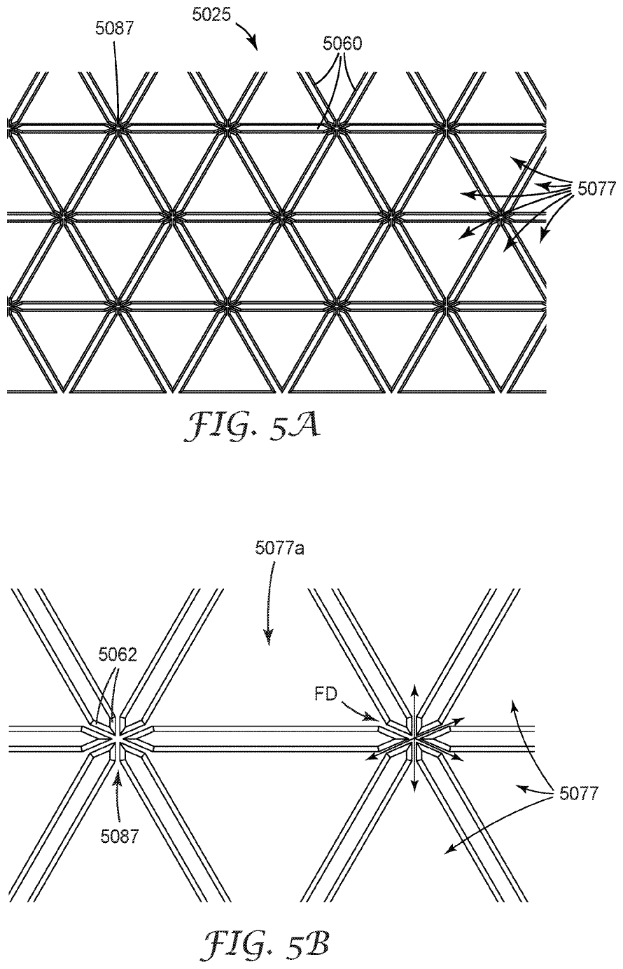

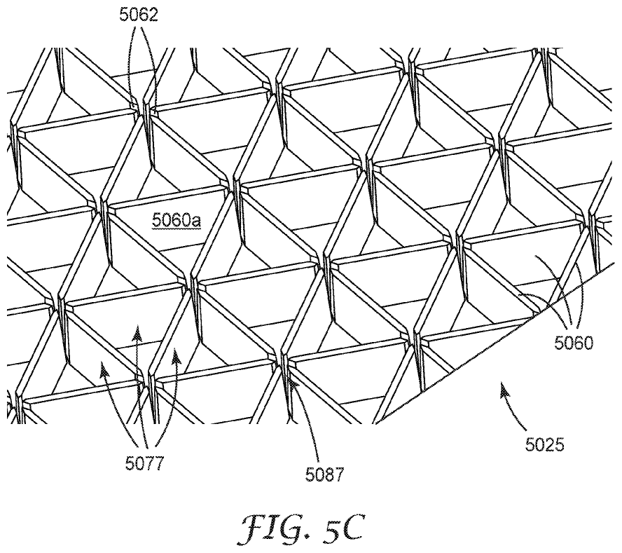

Referring to FIG. 5A, a schematic top view is provided of a portion of a microstructured substrate 5025 having an array of fluidically connected wells 5087 having a triangular shape, connected by vents 5087. FIG. 5B is a close-up of a portion of FIG. 5A, where it can clearly be seen that each vent 5087 connects six wells 5077. As such, when fluid flows out of a well 5077a in a certain flow direction (“FD”), it can enter up to five other adjacent wells 5077. Moreover, in this embodiment, each well 5077 can be fluidically connected to up to twelve adjacent wells.

FIG. 5C provides a schematic perspective view of a portion of the microstructured substrate 5025 of FIG. 5A to give an alternate view of the microstructures 5060. One way of providing such microstructures 5060 as are located in a center (e.g., not adjacent to a perimeter) of the microstructured substrate 5025, such as 5060a, is to form a series of spaced apart planar panels with beveled edges 5062 (as shown in each of FIGS. 5B and 5C).

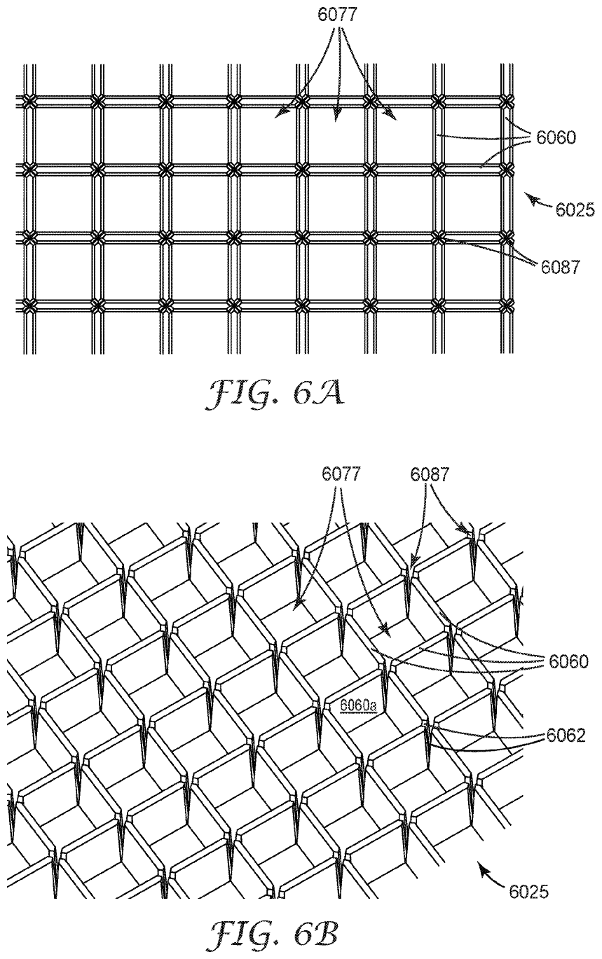

Referring to FIG. 6A, a schematic top view is provided of a portion of a microstructured substrate 6025 having an array of fluidically connected wells 6077 having a square shape, connected by vents 6087 at the corners of the squares. Moreover, in this embodiment, each well 6077 can be fluidically connected to up to six adjacent wells. FIG. 6B provides a schematic perspective view of a portion of the microstructured substrate 6025 of FIG. 6A to give an alternate view of the microstructures 6060. Like the triangular shaped wells of FIGS. 5A-B, one way of providing such microstructures 6060 as are located in a center (e.g., not adjacent to a perimeter) of the microstructured substrate 6025, such as 6060a, is to form a series of spaced apart planar panels with beveled edges 6062.

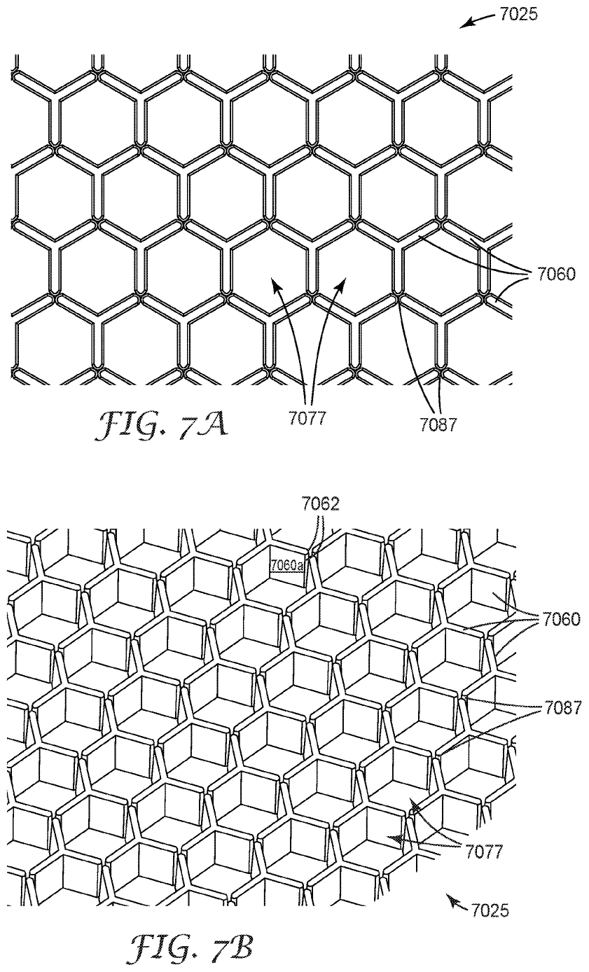

Referring to FIG. 7A, a schematic top view is provided of a portion of a microstructured substrate 7025 having an array of fluidically connected wells 7077 having a hexagonal shape, connected by vents 7087 at the corners of the hexagons. Moreover, in this embodiment, each well 7077 can be fluidically connected to up to six adjacent wells. FIG. 7B provides a schematic perspective view of a portion of the microstructured substrate 7025 of FIG. 7A to give an alternate view of the microstructures 7060. Similar to the circular shaped wells of FIGS. 3A-B, one way of providing such microstructures 7060 as are located in a center (e.g., not adjacent to a perimeter) of the microstructured substrate 7025, such as 7060a, is to form a series of spaced apart planar panels (e.g., symmetric) trilobal segments with beveled edges 7062.

Variations on the specific structures described herein is expressly contemplated.

Devices including microstructured substrates according to at least certain embodiments of the present disclosure are suitable for use to remove solid particles (e.g., red blood cells) from a fluid (e.g., blood) when a sample volume is 120 microliters or less, 110 microliters, 100 microliters, 90 microliters, 80 microliters, 70 microliters, 60 microliters, 50 microliters, 40 microliters, 30 microliters, 20 microliters, 10 microliters, or even 5 microliters or less; and 1 microliter or more, 2 microliters, 3 microliters, 4 microliters, 5 microliters, 6 microliters, 7 microliters, 8 microliters, 9 microliters, 10 microliters, 12 microliters, 15 microliters, 25 microliters, 35 microliters, or 45 microliters or more. For instance, a total of the first open volume and the second open volume may be between 5 microliters and 120 microliters.

Connected well structures can be made using a multi-photon exposure system as described in U.S. Pat. No. 8,605,256 (De Voe et al.) to create a patterned tooling. Such structured polymer tools are typically then plated with nickel to create metallized tools. Next, nickel-plated tools are used to make impression molded samples using a press such as a Carver Press (Carver, Wabash, IN) and a resin (e.g., polypropylene resin. Press platens are heated (e.g., to 170° C.), then the tool and resin are pressed together at high force (e.g., 1000 force pounds) for several minutes (e.g., 5-10 minutes). Following cooling (e.g., until the platen temperature reaches 80° C.), pressure is released and molded samples can be removed. Using such a method can optionally provide the microstructured substrate in a form of a microstructured film.

In one embodiment, a microstructured substrate can be prepared by a method including the steps of (a) preparing a polymerizable composition; (b) depositing the polymerizable composition onto a master negative microstructured molding surface (e.g., tool) in an amount barely sufficient to fill the cavities of the master; (c) filling the cavities by moving a bead of the polymerizable composition between a (e.g., preformed film) base layer and the master, at least one of which is flexible; and (d) curing the composition. The deposition temperature can range from ambient temperature to about 180° F. (82° C.). The master can be metallic, such as nickel, chrome- or nickel-plated copper or brass, or can be a thermoplastic material that is stable under the polymerization conditions and has a surface energy that allows clean removal of the polymerized material from the master. When the base layer is a preformed film, one or more of the surfaces of the film can optionally be primed or otherwise be treated to promote adhesion with the organic material of the microstructures.

The polymerizable resin can comprise a combination of a first and second polymerizable component selected from (meth)acrylate monomers, (meth)acrylate oligomers, and mixtures thereof. As used herein, “monomer” or “oligomer” is any substance that can be converted into a polymer. The term “(meth)acrylate” refers to both acrylate and methacrylate compounds. In some cases, the polymerizable composition can comprise a (meth)acrylated urethane oligomer, (meth)acrylated epoxy oligomer, (meth)acrylated polyester oligomer, a (meth)acrylated phenolic oligomer, a (meth)acrylated acrylic oligomer, and mixtures thereof.

The polymerizable resin can be a radiation curable polymeric resin, such as a UV curable resin. In some cases, polymerizable resin compositions useful for the microstructured substrates of the present disclosure can include polymerizable resin compositions such as are described in U.S. Pat. No. 8,012,567 (Gaides et al.).

Alternatively, a microstructured substrate can be prepared by melt extrusion, i.e., casting a fluid resin composition onto a master negative microstructured molding surface (e.g., tool) and allowing the composition to harden. Suitable resin compositions for melt extrusion are transparent materials that are dimensionally stable, durable, weatherable, and readily formable into the desired configuration. Examples of suitable materials include acrylics, such as Plexiglas brand resin manufactured by Rohm and Haas Company (Philadelphia, PA); polycarbonates; reactive materials such as thermoset acrylates and epoxy acrylates; polyethylene based ionomers, such as those marketed under the brand name of SURLYN by Dow Chemical (Midland, MI) E. I. Dupont de Nemours and Co., Inc.; (poly)ethylene-co-acrylic acid; polyesters; polyurethanes; and cellulose acetate butyrates.

In yet another embodiment, the master negative microstructured molding surface (e.g., tool) can be employed as an embossing tool, such as described in U.S. Pat. No. 4,601,861 (Pricone).

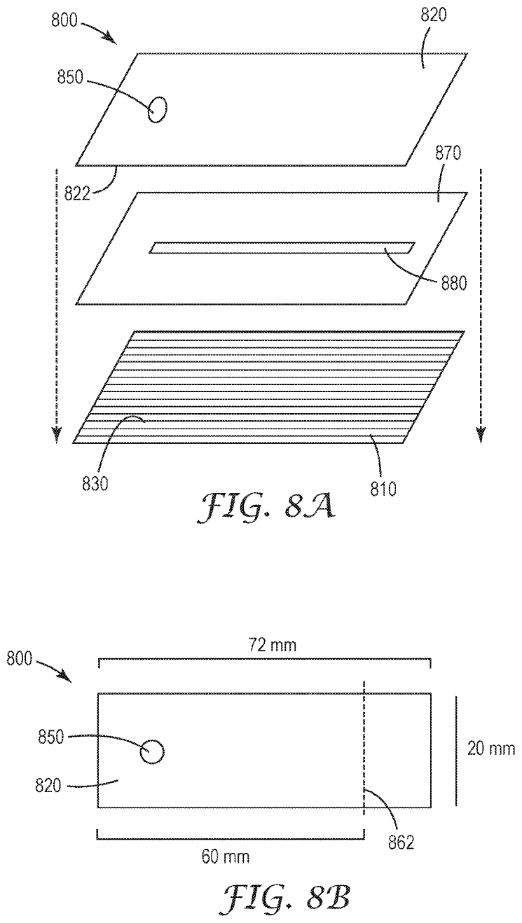

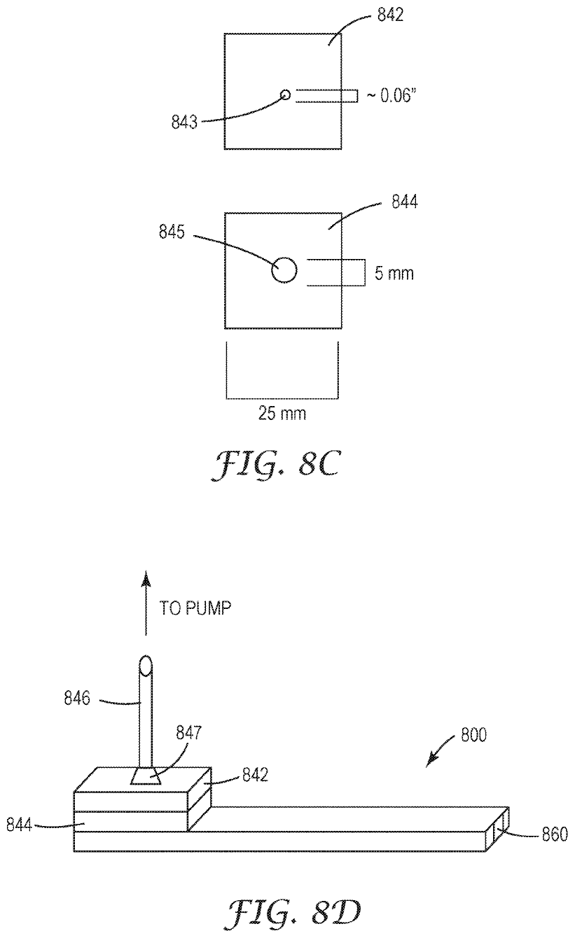

In some cases, microstructured substrates as disclosed herein may be useful to include in a device and/or method for separation of particles from fluids, such as described in co-owned Application Ser. Nos. 63/425,468 (Docket No. PA100124US02) and 63/425,483 (Docket No. PA100776US01), incorporated herein by reference in their entireties. For instance, referring to FIGS. 8A-8D, FIG. 8A is an exploded generalized schematic diagram of one device in which an exemplary microstructured substrate could be employed. It is noted that the microstructured surface 810 does not show interconnected wells but rather a general representation of linear microstructures 830. FIG. 8B is a generalized schematic top view of the device of FIG. 8A. FIG. 8C are generalized schematic top views of two components used to attach a pump affixed to the device of FIGS. 8A-8B. FIG. 8D is a generalized schematic perspective view of the device of FIGS. 8A-8B adapted to be attached to a pump. FIGS. 8A-8D are described in further detail in Example 1 of co-owned Application Ser. No. 63/425,468 (Docket No. PA100124US02).

### EXEMPLARY EMBODIMENTS

In a first embodiment, the present disclosure provides a microstructured substrate. The microstructured substrate comprises a plurality of microstructures extending across a first surface of the microstructured substrate. The microstructures comprise an array of interconnected wells and at least some of the wells are fluidically connected to at least two adjacent wells, each connection via a vent. Each well has an open volume ranging from 100 femtoliters to 1 microliter. At least a portion of an exterior surface of the plurality of microstructures are configured to allow capillary action.

In a second embodiment, the present disclosure provides a microstructured substrate according to the first embodiment, wherein at least some of the wells are fluidically connected to three adjacent wells or four adjacent wells, each connection via a vent.

In a third embodiment, the present disclosure provides a microstructured substrate according to the first embodiment or the second embodiment, wherein the wells have a depth ranging from 50 micrometers to 500 micrometers.

In a fourth embodiment, the present disclosure provides a microstructured substrate according to any of the first through third embodiments, wherein the wells have a diameter ranging from 50 micrometers to 500 micrometers.

In a fifth embodiment, the present disclosure provides a microstructured substrate according to any of the first through fourth embodiments, wherein at least some of the vents have a width ranging from 1 micrometer to 40 micrometers.

In a sixth embodiment, the present disclosure provides a microstructured substrate according to any of the first through fifth embodiments, wherein at least some of the vents between wells are located at a same depth as a bottom of the adjacent wells.

In a seventh embodiment, the present disclosure provides a microstructured substrate according to any of the first through six embodiments, wherein at least some of the vents between wells have a total depth equal to the total depth of the adjacent wells.

In an eighth embodiment, the present disclosure provides a microstructured substrate according to any of the first through seventh embodiments, wherein the wells comprise a curvilinear shape, a polygonal shape, an irregular shape, or combinations thereof.

In a ninth embodiment, the present disclosure provides a microstructured substrate according to any of the first through eighth embodiments, wherein the wells comprise a circular shape, a triangular shape, a quadrilateral shape, an elliptical shape, or combinations thereof.

In a tenth embodiment, the present disclosure provides a microstructured substrate according to any of the first through ninth embodiments, wherein the wells comprise a circular shape.

In an eleventh embodiment, the present disclosure provides a microstructured substrate according to any of the first through ninth embodiments, wherein the wells comprise a shape comprising a corner and a vent is located at the corner.

In a twelfth embodiment, the present disclosure provides a microstructured substrate according to any of the first through eleventh embodiments, wherein each well has an open volume ranging from 500 femtoliters to 0.1 microliters.

In a thirteenth embodiment, the present disclosure provides a microstructured substrate according to any of the first through twelfth embodiments, wherein at least a portion of the exterior surface of the plurality of microstructures comprises a surfactant, a surface treatment, a hydrophilic polymer, or any combination thereof.

In a fourteenth embodiment, the present disclosure provides a microstructured substrate according to any of the first through thirteenth embodiments, wherein the microstructured substrate is a microstructured film.

In a fifteenth embodiment, the present disclosure provides a microstructured substrate according to any of the first through fourteenth embodiments, further comprising at least one sidewall disposed along a perimeter of the first surface of the microstructured substrate.

In a sixteenth embodiment, the present disclosure provides a microstructured substrate according to any of the first through fifteenth embodiments, wherein the at least one sidewall has a height that extends beyond a top surface of the plurality of microstructures by 50 to 250 micrometers.

In a seventeenth embodiment, the present disclosure provides a microstructured substrate according to the sixteenth embodiment, wherein the first surface of the microstructured substrate together with the at least one sidewall defines a first open volume that is a total of open space located within the wells and the vents, wherein a top surface of the at least one sidewall together with the top surface of the plurality of microstructures defines a second open volume adjacent to the first open volume, wherein the first open volume is larger than the second open volume.

### EXAMPLES

Objects and advantages of this disclosure are further illustrated by the following examples, but the particular materials and amounts thereof recited in these examples, as well as other conditions and details, should not be construed to unduly limit this disclosure. Unless otherwise noted or otherwise apparent from the context, all parts, percentages, ratios, etc. in the Examples and the rest of the specification are by weight.

### Example 1. Microstructured Substrate

A CAD design file was used to fabricate a masterform of a microstructured substrate using a multi-photon exposure system described in U.S. Pat. No. 8,605,256 (De Voe et al.) and U.S. Pat. No. 8,455,846 (Gates et al.). A negative contrast photoresist, such as described in U.S. Pat. No. 10,133,174 (Lee et al.), was photo-patterned on a silicon wafer substrate. When scanning was completed, the substrate with the patterned structures was immersed in a development solution of propylene glycol monomethyl ether acetate (obtained from Sigma-Aldrich) to remove unpolymerized photoresist. The masterform was then nickel or nickel alloy electroformed to create the metal tool that was used for replication. The nickel plated tool was used to make impression molded samples with polypropylene resin (C700-35 resin, Dow Chemical, Midland, MI). The platens of a Carver press (Carver, Wabash, IN) were heated to 170° C. and the tool and resin were pressed together for 7 minutes at 1000 force pounds (˜4450 Newtons), followed by cooling under pressure until the temperature of the platens reached 80° C. The pressure was released and the molded microstructured substrate was removed from the tool.

The molded microstructured substrate had an upper surface and lower surface with overall dimensions of 25.4 mm (width), 76.2 mm (length), 1 mm (depth). The microstructures of the substrate were an array of fluidically connected wells having circular shapes connected to adjacent wells by vents (shown in FIGS. 1A and 1B) positioned in a flow channel (3 mm width, 40 mm length) that was recessed below the upper surface of the substrate and had first and second open ends. Each well had a diameter of 200 micrometers, depth of 150 micrometers, and draft angle of 5 degrees. The vents had a length of 29 micrometers, width of 40 micrometers, a depth of 150 micrometers, and draft angle of 5 degrees. The wells located in the center of the flow channel were each connected to four other wells with each connection being via a vent and the spacing of vents being as shown in FIG. 1B. The wall surrounding the perimeter of the flow channel extended 100 micrometers above the top surfaces of the wells.

The first open end of the flow channel was fluidically attached to a semi-circular first cavity having a depth of 100 micrometers from the upper surface and a volume of 2.88 microliters. The first cavity formed the first aperture of the device. The first aperture served as the liquid sample intake reservoir of the final device. The opposite, second open end of the flow channel was fluidically attached to a rectangular shaped second cavity (5 mm width, 6 mm length, 250 micrometer depth from the upper surface). The second cavity formed the second aperture of the device. The second aperture served as the receiving reservoir for liquid sample exiting the flow channel.

### Comparative Example A

Devices without a microstructured surface in the flow channel were prepared as Comparative Example A for testing with the method of Example 2. Each device was prepared by forming a laminate of three film sections. The cover sheet component of the device was prepared by laser cutting a 72 mm long by 20 mm wide section from a sheet of 3M Microfluidic Diagnostic Film 9962. A circular hole (5 mm diameter) was laser cut into the film such that the center of the hole was positioned 13.5 mm in a perpendicular direction from the narrow edge of the film and 10 mm in a perpendicular direction from the long edge of the film. The circular hole formed the first aperture of the device. The second film component of the device was prepared by laser cutting a 72 mm long by 20 mm wide section from a sheet of 3M 1522 Double-Sided Medical Tape (a clear, double sided acrylic adhesive with a polyethylene backing, obtained from the 3M Company). The overall thickness of the double-sided tape with release liners removed was measured to be 150 micrometers using a digital caliper. A rectangular opening (60 mm long by 2.5 mm wide) was laser cut into the second film component and oriented such that the narrow edges of the opening were positioned 11 mm from the narrow edges of the film and the long edges of the opening were positioned 8.75 mm from the long edges of the film.

The third film component of the device was a 72 mm long by 20 mm wide laser cut section of a non-microstructured polyethylene terephthalate (PET) film (MELINEX 454 film (3 mil), Dupont Teijin Films). All of the laser cuts in films were done using a Muse Core CO₂ Laser Cutter (Full Spectrum Laser, Las Vegas, Nevada).

The device was constructed by removing any release liners from the films and then edge aligning the films into a stack with the second film sandwiched between the cover sheet film and the microstructured film. Adhesive lamination of the stack was completed by applying a 4 pound (1.8 kilogram) roller to the stack with one back-and-forth motion of the roller. The second adhesive film formed a fluid seal between the cover sheet and top surface of the microstructured film around the edges of the rectangular opening and first aperture hole (e.g., forming a sidewall). In the final step, a razor blade was used to trim the stack at the edge located distal from the first aperture so that the resulting device had overall dimensions of 60 mm long by 20 mm wide. This cut through the opening in the second film exposed the second aperture of the device as a 2.5 mm rectangular opening in the newly created edge of the device.

### Example 2. Method of Separating Red Blood Cells from Blood

Human blood was collected in BD VACUTAINER citrate tubes (Becton, Dickinson and Company, Franklin Lakes, NJ) and used as citrated whole blood or citrated whole blood diluted 1:1 with 1X phosphate buffered saline (PBS) (GIBCO 1X Phosphate Buffered Saline, pH 7.4, obtained from Thermo Fisher Scientific, Waltham, MA).

The microstructured substrate described in Example 1 was prepared and a cover component modified with tubing for blood instillation was attached to each substrate. The modified cover component was a section of 3M Microfluidic Diagnostic Film 9975R (obtained from the 3M Company) with a circular hole (5 mm diameter) laser cut into the cover component. Plastic tubing (0.05 inch ID, 0.09 inch OD) was inserted into the hole and secured with epoxy adhesive (3M SCOTCH-WELD Epoxy Adhesive DP100 Plus Clear, obtained from the 3M Company). Any tubing that extended beyond the adhesive surface of the cover component was removed with a razor blade. The cover was positioned over the flow channel and the liquid sample intake reservoir sections of the microstructured substrate and adhesively attached to the surface of the microstructured substrate that surrounded the two sections. The cover component was oriented so that the center of the hole was positioned over the center of the sample intake reservoir on attachment of the cover. The receiving reservoir was not covered. The tubing extended about 3 cm in length from the outer surface of the cover.

Each resulting device was placed on a horizontal surface (oriented so that the lower surface of the device faced the horizontal surface). A sample of blood (20-50 microliters) was added through the tubing to the sample inlet reservoir using a micropipette. The blood sample was allowed to wick to the end of the device by capillary flow or was advanced using positive pressure from the micropipette. A sufficient volume of blood was added to the device to fill the open volume of the flow channel without having excess blood in the intake reservoir. Any excess blood in the receiving reservoir was promptly removed from the reservoir using a micropipette or a KIMWIPE wiper (Kimberly-Clark Corporation, Irving, TX). Following administration of the blood sample, each device was maintained undisturbed on the horizontal surface for 5 minutes.

A 1 mL Luer-Lok syringe filled with mineral oil was attached to a section of plastic tubing and the mineral oil was partially dispensed into the tubing to leave a small air gap (about 10 cm of tubing length) at the open end of the tubing. The syringe was placed in a syringe pump (model NE-1600, New Era Pump Systems Inc). The open end of the tubing of the syringe assembly was connected to the open end of the tubing that extended from the device. The pump was activated with the flow rate set to 50 microliters/minute to force the blood sample from the flow channel with the volume of entrapped air. The blood sample that flowed out of the flow channel was collected as several 2-4 microliter aliquots. Each sample was collected as soon as an aliquot volume accumulated in the receiving reservoir.

For each collected sample, dilution samples of 1/10, 1/20, 1/100, and 1/200 in 1×PBS were prepared. A 2 microliter aliquot of each dilution sample was loaded onto an Agilent Take3 microvolume plate (TAKE3-SN, Agilent Technologies, Santa Clara, CA) with a micropipette. The plate included at least 1 well as a 1×PBS blank that was used for the dilutions per the manufacturer instructions. For each sample and for the 1×PBS blank, absorbance measurements were recorded at 406 nm, 414 nm, and 576 nm using an Agilent Synergy Neo2 plate reader (Agilent Technologies). The procedure in the section “Method for Determining Intact Red Blood Cell Content of Samples” (described below) was used to calculate the percent reduction of red blood cells from the blood samples submitted to each device using the procedure described in this example. The same procedure was conducted using the device of Comparative Example A with blood delivered to the first aperture of the device through adhesively attached tubing.

The results using citrated human whole blood are provided in Table 1 and the results using citrated human whole blood diluted 1:1 in 1×PBS are presented in Table 2. The results reported in Tables 1 and 2 are from technical replicates of three devices (n=3). The calculated percent reduction in red blood cells for each replicate device was averaged from the entire volume of aliquot samples collected from the device.

TABLE 1

| Device Prepared with | Percent RBC | Standard |
|---|---|---|
| Microstructured Substrate from | Reduction | Deviation |
| Example 1 | 14.1% | 10.5% |
| Comparative Example A | −1.2% | 6.7% |

TABLE 2

| Device Prepared with | Percent RBC | Standard |
|---|---|---|
| Microstructured Substrate from | Reduction | Deviation |
| Example 1 | 35.0% | 9.7% |
| Comparative Example A | 4.7% | 10.9% |

### Method for Determining Intact Red Blood Cell Content of Samples

In order to simultaneously measure intact red blood cell content and lysed red blood cell content of samples, a calibration curve of a dilution series was prepared with known inputs of lysed and intact human red blood cells. Citrated human whole blood was used as the sample of 100% intact red blood cells. To create a 0% intact red blood cell sample, an aliquot of whole blood was lysed by vortexing for 1 minute using a ZR BashingBead lysis tube (product no. S6012-50, Zymo Research, Irvine, CA). The tube was centrifuged at 10,000×g for 1 minute and the supernatant, containing only lysed cell content, was transferred to a fresh 1.5 mL Eppendorf tube. Standard samples of intact-to-lysed red blood cells for a dilution series were prepared by mixing varying ratios of known intact and lysed cells that ranged from 100% to 0% intact red blood cells. The intact red blood cell concentrations of the standard samples were confirmed using a C-CHIP Disposable Hemacytometer according to the manufacturer's instructions.

Each standard sample was diluted in 1×PBS (so that the absorbances would be in the dynamic range of the plate reader) and analyzed in technical triplicate using an Agilent Synergy Neo2 plate reader with the Take 3 multivolume plate (sample volumes and blanks were selected per manufacturer instructions). Absorbances at 406 nm, 414 nm, and 576 nm were measured for each standard sample).

The ratio of A₄₁₄ₙₘ/A₅₇₆ₙₘ was plotted versus the known input of % intact red blood cells. A₄₁₄ₙₘ=the sample absorbance at 414 nm and A₅₇₆ₙₘ=the sample absorbance at 576 nm. The subtraction of the blank (1×PBS) was used for background subtraction. The dataset was fitted with a logarithmic curve to generate Equation A. Equation A was used to calculate the percentage of intact red blood cells from a suspension containing blood.

$$\% intact = - 4 9.6 ln ( \frac{{A}_{414 nm} - {A}_{PBS , 414 nm}}{{A}_{576 nm} - {A}_{PBS , 576 nm}} ) + 100 \qquad Equation A$$

In Equation A, “% intact”=the percentage of the red blood cells in the suspension that were intact, “A₄₁₄ₙₘ”=the absorbance of the 414 nm wavelength of the blood sample, “A_{PBS,414nm}”=the absorbance of the 414 nm wavelength of 1×PBS, “A₅₇₆ₙₘ”=the absorbance of the 576 nm wavelength of the blood sample, and “A_{PBS,576nm}”=the absorbance of the 576 nm wavelength of 1×PBS.

The absorbance signal at 406 nm of each sample was adjusted by the ratio of percent cells to calculate the signal from intact red blood cells with Equation B.

$${Ai}_{406 nm} = \frac{\% intact}{100 \%} \times ( {A}_{406 nm} - {A}_{PBS , 406 nm} ) \qquad Equation B$$

In Equation B, “Ai₄₀₆ₙₘ”=the absorbance of the 406 nm wavelength of the blood sample attributed to intact red blood cells, “% intact”=the percentage of the red blood cells in suspension that are intact as calculated by Equation A, “A₄₀₆ₙₘ”=the absorbance of the 406 nm wavelength of the sample, and “A_{PBS,406nm}”=the absorbance of the 406 nm wavelength of 1×PBS.

After the absorbance of the 406 nm wavelength was adjusted for intact and lysed cells in Equation B, the absorbance signal of a blood sample added to a device was compared to the absorbance signal of the corresponding blood aliquots collected from the device according to Equation C in order to calculate the percent red blood cell (RBC) reduction.

$$Percent red blood cell reduction = \frac{{Ai}_{406 nm , input} - {Ai}_{406 nm , output}}{{Ai}_{406 nm , input}} \times 100 \qquad Equation C$$

In Equation C, “Ai_{406nm, input}”=the absorbance of the 406 nm wavelength of the blood sample added to the device attributed to intact red blood cells, as calculated by Equation B and “Ai_{406nm, output}”=the absorbance of the 406 nm wavelength of the blood sample collected from the device attributed to intact red blood cells, as calculated by Equation B.

All of the patents and patent applications mentioned above are hereby expressly incorporated by reference. The embodiments described above are illustrative of the present invention and other constructions are also possible. Accordingly, the present invention should not be deemed limited to the embodiments described in detail above and shown in the accompanying drawings, but instead only by a fair scope of the claims that follow along with their equivalents.

1. A microstructured substrate comprising a plurality of microstructures extending across a first surface of the microstructured substrate, wherein the microstructures comprise an array of interconnected wells; wherein at least some of the wells are fluidically connected to at least two adjacent wells, each connection via a vent; wherein each well has an open volume ranging from 100 femtoliters to 1 microliter; and wherein at least a portion of an exterior surface of the plurality of microstructures are configured to allow capillary action.

2. The microstructured substrate of claim 1, wherein at least some of the wells are fluidically connected to three adjacent wells or four adjacent wells, each connection via a vent.

3. The microstructured substrate of claim 1 or claim 2, wherein the wells have a depth ranging from 50 micrometers to 500 micrometers.

4. The microstructured substrate of any of claims 1 to 3, wherein the wells have a diameter ranging from 50 micrometers to 500 micrometers.

5. The microstructured substrate of any of claims 1 to 4, wherein at least some of the vents have a width ranging from 1 micrometer to 40 micrometers.

6. The microstructured substrate of any of claims 1 to 5, wherein at least some of the vents between wells are located at a same depth as a bottom of the adjacent wells.

7. The microstructured substrate of any of claims 1 to 6, wherein at least some of the vents between wells have a total depth equal to the total depth of the adjacent wells.

8. The microstructured substrate of any of claims 1 to 7, wherein the wells comprise a curvilinear shape, a polygonal shape, an irregular shape, or combinations thereof.

9. The microstructured substrate of any of claims 1 to 8, wherein the wells comprise a circular shape, a triangular shape, a quadrilateral shape, an elliptical shape, or combinations thereof.

10. The microstructured substrate of any of claims 1 to 9, wherein the wells comprise a circular shape.

11. The microstructured substrate of any of claims 1 to 9, wherein the wells comprise a shape comprising a corner and a vent is located at the corner.

12. The microstructured substrate of any of claims 1 to 11, wherein each well has an open volume ranging from 500 femtoliters to 0.1 microliters.

13. The microstructured substrate of any of claims 1 to 12, wherein at least a portion of the exterior surface of the plurality of microstructures comprises a surfactant, a surface treatment, a hydrophilic polymer, or any combination thereof.

14. The microstructured substrate of any of claims 1 to 13, wherein the microstructured substrate is a microstructured film.

15. The microstructured substrate of any of claims 1 to 14, further comprising at least one sidewall disposed along a perimeter of the first surface of the microstructured substrate.

16. The microstructured substrate of claim 15, wherein the at least one sidewall has a height that extends beyond a top surface of the plurality of microstructures by 50 to 250 micrometers.

17. The microstructured substrate of claim 16, wherein the first surface of the microstructured substrate together with the at least one sidewall defines a first open volume that is a total of open space located within the wells and the vents, wherein a top surface of the at least one sidewall together with the top surface of the plurality of microstructures defines a second open volume adjacent to the first open volume, wherein the first open volume is larger than the second open volume.
